(19) United States
(12) Patent Application Publication
(10) Pub. No.: US 2009/0133368 A1
(43) Pub. Date: May 28, 2009

(54) Exhaust conduit and adapter mounting for portable oxygen concentrator

(76) Inventors: Wade Frank Calkins, Cardston (CA); Julie Calldge, Cardston (CA)

Correspondence Address: Antony C. Edwards, P.O. Box 26020, Westbank, BC, V4T 2G3, CA

(21) Appl. No.: 12/320,405

(22) Filed: Jan. 26, 2009

Related U.S. Application Data
(63) Continuation-in-part of application No. 11/240,572, filed on Oct. 3, 2005, now abandoned.

(51) Int. Cl. B01D 50/00

(52) U.S. Cl. 55/383

(57) ABSTRACT

An exhaust conduit and adapter apparatus for mounting to a pair of exhaust outlets mounted oppositely on the base of a portable oxygen concentrator includes an opposed facing pair of substantially unshaped hollow conduits wherein each conduit has an inlet end and an outlet end. The inlet ends are separated by a distance equal to a separation distance between the pair of exhaust outlets. The outlet ends are mounted to each other in fluid communication with a junction having a single outlet. The inlet ends are adapted for mounting to the pair of exhaust outlets so that, when so mounted, hot exhaust from the oxygen concentrator flows through each conduit and out through the junction and the single outlet of the junction. An outflow conduit is mountable to the single outlet of the junction for outflow of the hot exhaust from the single outlet to a remote location, remote from a patient using the oxygen concentrator.

### FIELD OF THE INVENTION

This invention relates to the field of portable oxygen concentrators and in particular to an exhaust conduit and adapter for mounting an exhaust conduit to the exhaust ports of portable oxygen concentrators.

### BACKGROUND OF THE INVENTION

Many patients require long term therapeutic oxygen treatment whether at home, in nursing homes, or in other settings. In the past it was known to provide pressurized concentrated oxygen in cylinders so that the patient metered oxygen from the cylinder for respiratory support. The drawback was of course that only a limited amount of pressurized oxygen could be stored in a cylinder and so, once used, a cylinder had to be returned to a re-filling facility and re-filled cylinders delivered for use by the patient. Consequently this was inconvenient and often expensive.

More recently, oxygen concentrators capable of concentrating the oxygen from ambient air using pressure swing absorption typically operating between a pair of molecular sieves, have become available in somewhat portable units well suited for use in a home or in nursing home or the like. These oxygen concentrators purport to be capable of delivering for example either five litres per minute or ten litres per minute of an airflow having a highly concentrated oxygen component, that is, concentrated to a therapeutic level, for example, approximately ninety percent or greater oxygen. Examples of a five litre per minute oxygen concentrator is the New Life Elite™ Oxygen Concentrator manufactured by Air Sep Corporation. Examples of ten litre per minute oxygen concentrators are the Millenium™ M10 Oxygen Concentrator manufactured by Respironics, Inc., and the Platinum™ 10 Oxygen Concentrator manufactured by Invacare Corporation.

As may be seen in the representative illustration in FIG. 1, these oxygen concentrators are sufficiently bulky and sufficiently heavy, weighing in the order of fifty or more pounds, that they are housed in an upright canister-like housing and typically supported on a base having three or more casters. By grasping a handle on the top of the canister, the oxygen concentrator may be wheeled on close enough so that an oxygen hose may reach the patient. The oxygen concentrators all require one or more compressors so as to cyclically drive the pressure swing cycles in the molecular sieves. The compressors are electrically powered. In the case of the Air Sep New Life Elite concentrator, according to the manufacturer's specifications, the concentrator purportedly consumes three hundred fifty watts during operation, and in the case of the Invacare Platimum 10 Oxygen Concentrator, purportedly consumes five hundred eighty-five watts during operation. Consequently, the compressors generate heat. Applicant has observed that the heat generated by such an oxygen concentrator is, for the most part, dissipated as heated exhaust flow. Thus, because of the heat, patients typically do not want these oxygen concentrator units positioned too near to them.

The hot exhaust from the oxygen concentrators may be, in applicant's experience, approximately thirty-five degrees Celsius. Consequently, the air temperature in a patient's room will rise due to the temperature of the exhaust, and the volume of exhaust flow. This may cause discomfort for the patient, especially in summer, and may cause the unnecessary use of additional air conditioning to cool the patient's room temperature.

### SUMMARY OF THE INVENTION

In summary, the present invention may be characterized in one aspect as including an exhaust conduit and adapter mounted to or for mounting to a pair of exhaust outlets mounted oppositely on the base of a portable oxygen concentrator, including an opposed facing pair of substantially u-shaped hollow conduits wherein each conduit of the pair of substantially u-shaped hollow conduits has an inlet end and an outlet end. The inlet ends of each conduit are in opposed facing relation and separated by a distance equal to a separation distance between the pair of exhaust outlets on the oxygen concentrator. The inlet ends are thus mounted over the exhaust outlets. The outlets of each conduit are mounted to each other in fluid communication with a junction having a single outlet.

The inlet ends of each conduit are adapted for mounting to the pair of exhaust outlets on the oxygen concentrator so that, when so mounted, hot exhaust from the oxygen concentrator flows through the each conduit and out through the single outlet of the junction. In one embodiment an outflow conduit is mounted or mountable to the single outlet of the junction for outflow of the hot exhaust from the single outlet to a remote location, remote from a patient using the oxygen concentrator.

In one embodiment the inlet ends of each conduit are adapted for mounting to the pair of exhaust outlets on the oxygen concentrator by means of a corresponding pair of protruding, shelf-like manifold extensions protruding in opposed relation from lower edges of the inlet ends so as to engage in fluid communication with the exhaust outlets when downwardly disposed for exhaust flow vertically downwards and are formed under the base of the oxygen concentrator. In other embodiment the exhaust outlets are disposed vertically on the sides of the concentrator so that exhaust leaves horizontally. In the latter, the inlet ends mount flush onto the exhaust outlets.

The inlet ends may be funnel-shaped rectangular manifolds channelling the exhaust from the exhaust outlets when rectangular into the pair of conduits, wherein the pair of conduits are substantially round in cross section.

The pair of conduits may both lie substantially in a common plane, for example so that the pair of conduits are substantially horizontal when mounted on the oxygen concentrator. The pair of conduits may advantageously wrap substantially around the base of the oxygen concentrator when mounted thereto.

### BRIEF DESCRIPTION OF THE DRAWINGS

FIG. 1 is, in top perspective view, a prior art oxygen concentrator, and in particular, a Respironics Millenium M5 Oxygen Concentrator.

FIG. 2 is, in bottom perspective view, a representation of an oxygen concentrator having combined bottom and side opening hot exhaust outlets.

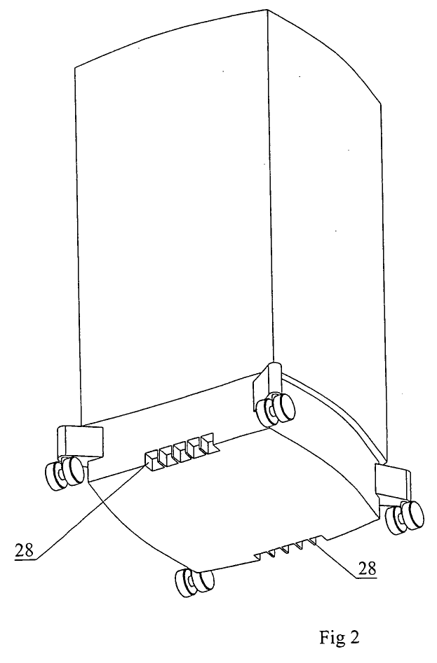

FIG. 3 is, in upper rear perspective view, one embodiment of the portable oxygen concentrator exhaust diverting conduits according to one aspect of the present invention for mounting onto the oxygen concentrator of FIG. 2.

FIG. 4 is, in bottom perspective view, a representation of an oxygen concentrator having only side opening hot exhaust outlets.

FIG. 5 is, in top front perspective view, a further embodiment of the oxygen concentrator exhaust diverting conduit according to a further aspect of the present invention for mounting onto the oxygen concentrator of FIG. 4.

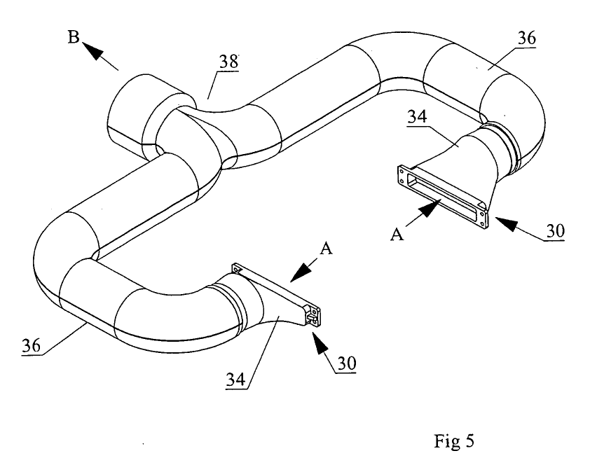

FIG. 6 is, in perspective view, a further embodiment of the oxygen concentrator exhaust diverting conduit according to the present.

FIG. 7 is, in perspective view, an in-line duct fan for extracting exhaust from the manifolds according to the present invention.

FIG. 8 is, in top perspective view, an oxygen concentrator mounted and sealed in a pan-style exhaust manifold according to one aspect of the present invention.

FIG. 8a is a top perspective view of one embodiment of a pan exhaust manifold according to the present invention.

FIG. 9 is, in bottom perspective view, a plate-style exhaust manifold mounted to a side surface of an oxygen concentrator so as to cover and seal the exhaust outlet of the concentrator.

### DETAILED DESCRIPTION OF EMBODIMENTS OF THE INVENTION

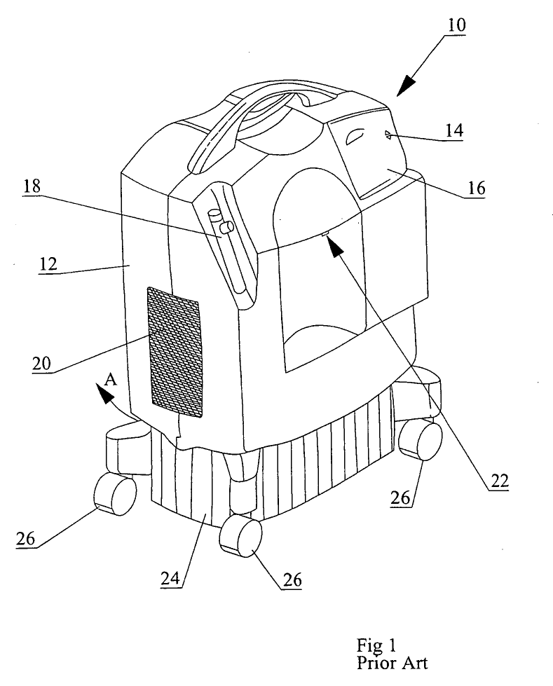

As seen in FIG. 1, a prior art portable oxygen concentrator 10 has a canister-like upper housing 12 encasing the compressor or compressors, molecular sieves, conduits etc, an on/off power switch 14, operating condition indicators such as LEDs 16, a flow meter 18, an air intake 20 and an oxygen outlet port 22. Housing 12 is mounted on a base 24, supported on a plurality of casters 26.

During operation of the oxygen concentrator, ambient air enters into the oxygen concentrator through air intake 20 and exits both as therapeutic oxygen from oxygen outlet port 22, and as heated exhaust in direction A being forced from exhaust outlets 28. Heated exhaust in direction A is forced from under base 24 in the space between the lower surface of the base and the floor on which the casters rest. The height of the space is governed by the height that casters 26 maintain base 24 above the floor surface. In the past, this design meant that little or nothing could be done to reduce the discomfort to the patient caused by proximity of the portable oxygen concentrator pumping out hot exhaust, often right at the feet of the patient.

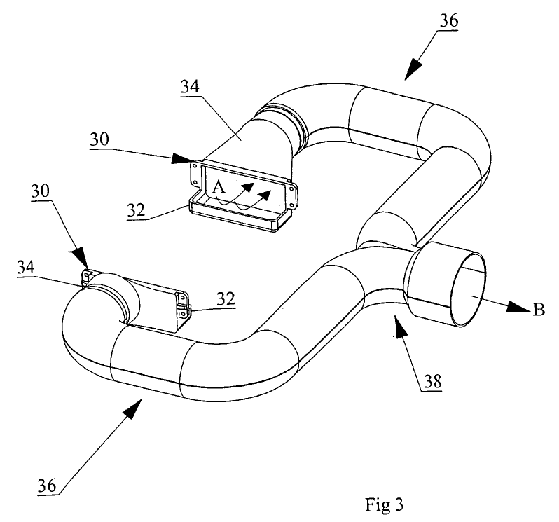

As seen in FIG. 3, in one embodiment of the present invention, exhaust manifolds 30 bolt or otherwise mount to the exterior of base 24 so as to extend exhaust trays 32 underneath base 24 in the space between base 24 and the floor so as to cover exhaust outlets 28. Thus exhaust trays 32 are sized so as to cover over exhaust outlets 28 so that exhaust flow in direction A is caught by exhaust trays 32 and directed into the hollow frusto-conical funnel portion 34 of exhaust manifolds 30.

The exhaust flow converges through funnel portions 34 into a corresponding pair of opposed facing U-shaped pipes 36. Exhaust flow is thus directed so as to wrap around base 24 and to converge at a common Y-junction pipe 38. Exhaust then flows in direction B from the single outlet of Y-junction pipe 38 through a hose or pipe, whether flexible or rigid, such as exhaust hose 40. The outlet end of exhaust hose 40 is directed for example through a window or otherwise so as to direct the hot exhaust away from the patient.

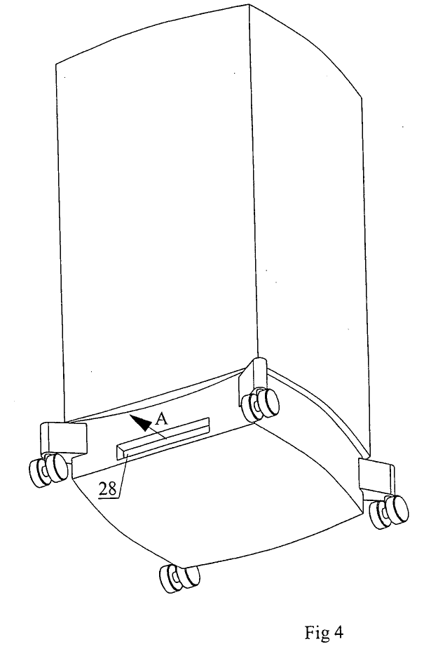

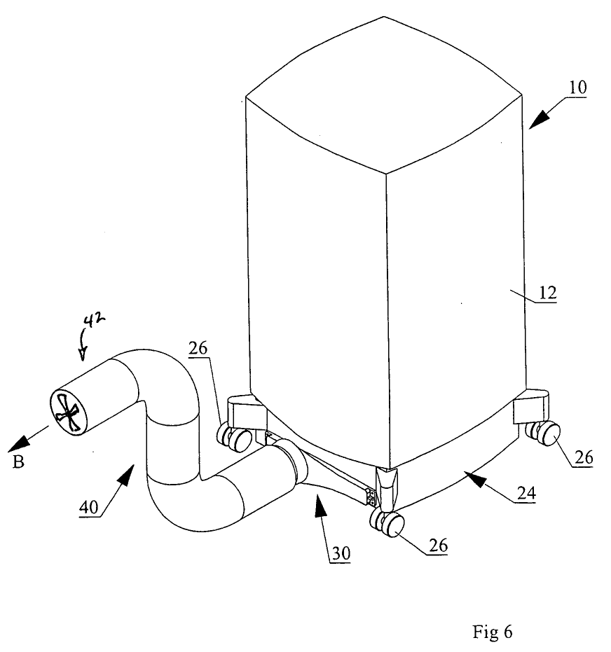

In the embodiment of FIG. 4, exhaust manifolds 30 do not require exhaust trays 32 in order to cover over exhaust outlets 28. This embodiment is for use on portable oxygen concentrators which exhaust from exhaust outlets which, although located on base 24, are directed laterally outwardly from the base. Similarly, in FIG. 6, the portable oxygen concentrator is only provided with a single exhaust outlet 28. Consequently, the pair of opposed facing U-shaped pipes 36 are unnecessary. Rather, only a single exhaust manifold 30 is require, again, rigidly mounted over exhaust outlet 28 so as to direct exhaust flow through exhaust hose 40 for venting through a window or the like.

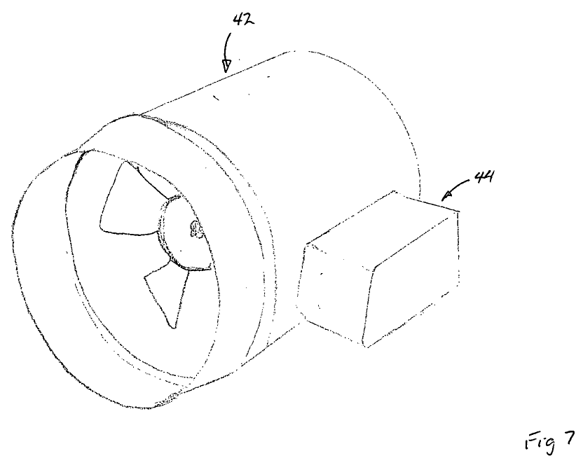

In a preferred embodiment an 42, as better seen in FIG. 7, is mounted in-line in, or in cooperation with, exhaust hose 40. In-line duct fan reduces static back pressure which otherwise causes the oxygen concentrator to overheat. In-line electrical on and off switch 44 may be provided to turn fan 42 on and off. Fan 42 may be such as sold by Waterline Power Air as model 1950101 Air Booster.

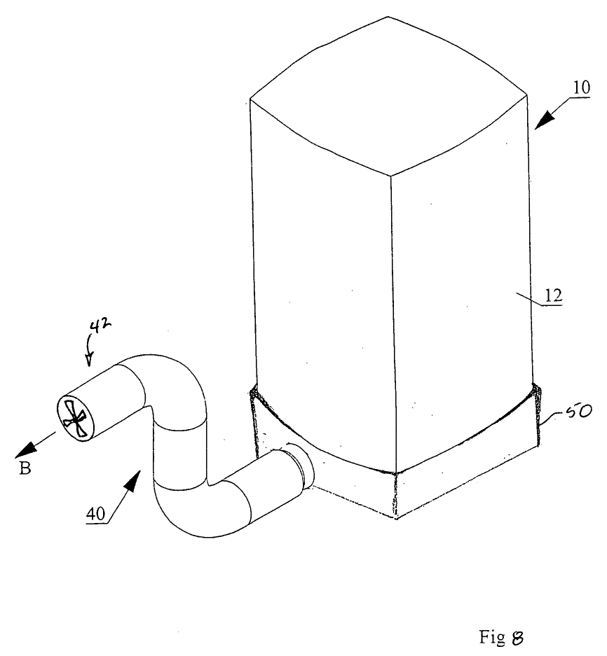

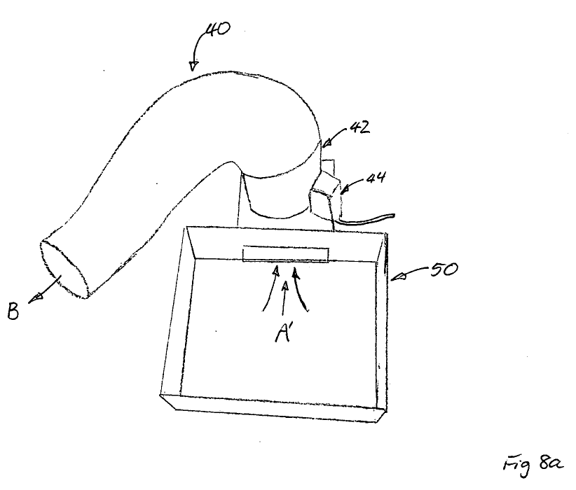

As seen in FIG. 8, the base 24 of the concentrator may be mounted in a pan 50, as also seen in FIG. 8a. Pan 50 envelopes the base of the concentrator and collects the hot exhaust from the underside of the concentrator. This is useful when there is insufficient clearance to put a plate-like collector under the base of the concentrator. The pan creates an exhaust manifold trapping the exhaust and re-directing it in direction A′ to base 40.

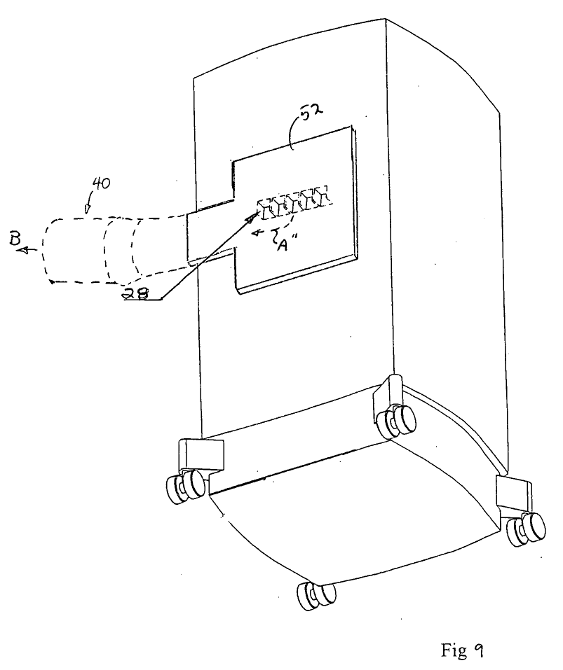

Plate-like exhaust collector 52 is useful for collecting exhaust from exhaust outlet 28, shown in dotted outline in FIG. 9, when the outlet is on for example a rear side surface of the concentrator. The plate-like collector is hallow and mounted as by screws for example so as to provide a shallow exhaust manifold re-directing exhaust in direction A″ into hose 40.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An exhaust conduit and adapter apparatus for mounting to an exhaust outlet on a portable oxygen concentrator, the apparatus comprising:
a) an exhaust outlet cover adaptor for completely covering the exhaust outlet of the concentrator and for re-directing hot exhaust from the outlet, the adaptor chosen from the group comprising:
(i) an opposed facing pair of substantially u-shaped hollow conduits wherein each conduit of said pair of substantially u-shaped hollow conduits has an inlet end and an outlet end, said inlet ends of said each conduit in opposed facing relation, said outlet of said each conduit mounted to each other in fluid communication with a junction having a single outlet, an outlet pipe in fluid communication with said single outlet, said inlet ends of said each conduit adapted for mounting to a corresponding pair of exhaust outlets on the oxygen concentrator so that, when so mounted, hot exhaust from the oxygen concentrator flows through said each conduit and out through said pipe,
(ii) a plate-like adaptor for mounting over an exhaust outlet on a substantially planar surface of the concentrator, wherein the planar surfaces includes an underside of the concentrator, a side surface of the concentrator,
(iii) a pan-shaped adaptor for mounting over a base of the concentrator when the exhaust outlet of the concentrator is on the underside of the concentrator and a clearance between the underside and a floor surface is restricted,
b) an outflow conduit mountable to said single outlet of said junction for outflow of the hot exhaust from said single outlet to a remote location, remote from a patient using the oxygen concentrator,
c) an in-line duct fan mounted in fluid communication with said pipe to extract exhaust from the concentrator.

2. The apparatus of claim 1 wherein said inlet ends of said each conduit are adapted for mounting to the pair of exhaust outlets on the oxygen concentrator by means of a corresponding pair of protruding, shelf-like manifold extensions protruding in opposed relation from lower edges of said inlet ends so as to engage in fluid communication with the exhaust outlets when downwardly disposed and formed under the base of the oxygen concentrator.

3. The apparatus of claim 1 wherein said inlet ends are funnel-shaped rectangular manifolds channelling the exhaust from the exhaust outlets when rectangular into said pair of conduits, wherein said pair of conduits are substantially round in cross section.

4. The apparatus of claim 2 wherein said inlet ends are funnel-shaped rectangular manifolds channelling the exhaust from the exhaust outlets when rectangular into said pair of conduits, wherein said pair of conduits are substantially round in cross section.

5. The apparatus of claim 1 wherein said pair of conduits both lie substantially in a common plane.

6. The apparatus of claim 2 wherein said pair of conduits both lie substantially in a common plane.

7. The apparatus of claim 5 wherein said pair of conduits are substantially horizontal when mounted on the oxygen concentrator.

8. The apparatus of claim 6 wherein said pair of conduits are substantially horizontal when mounted on the oxygen concentrator.

9. The apparatus of claim 7 wherein said pair of conduits wrap substantially around the base of the oxygen concentrator when mounted thereto.

10. The apparatus of claim 8 wherein said pair of conduits wrap substantially around the base of the oxygen concentrator when mounted thereto.
